(19) United States
(12) Patent Application Publication
(10) Pub. No.: US 2025/0187531 A1
(43) Pub. Date: Jun. 12, 2025

(54) VEHICLE LAMP

(71) Applicant: Stanley Electric Co., Ltd., Tokyo (JP)

(72) Inventors: Junpei INMARU, Meguro-ku, Tokyo (JP); Tadashi KAWATA, Meguro-ku, Tokyo (JP); Jun ANDO, Meguro-ku, Tokyo (JP)

(73) Assignee: Stanley Electric Co., Ltd., Tokyo (JP)

(21) Appl. No.: 18/845,053

(22) PCT Filed: Mar. 9, 2023
(86) PCT No.: PCT/JP2023/009028

§ 371 Date: Sep. 9, 2024

(30) Foreign Application Priority Data
Mar. 15, 2022 (JP) 2022-040358

(51) Int. Cl. B60Q 1/24; G01S 7/481; G01S 17/931

(52) U.S. Cl. CPC B60Q 1/249; G01S 7/4813; G01S 17/931

(57) ABSTRACT

There is provided a vehicle lamp that can transmit light for detecting a detection object (e.g., preceding vehicle, oncoming vehicle, pedestrian, bicycle, and motorcycle) transmitted from a LiDAR apparatus to an appropriate range based on a road condition around a vehicle (and receive return light thereof). The vehicle lamp includes: a LiDAR apparatus including a light source configured to emit light for detecting a detection object transmitted to a first detection range, and a light reception element configured to output, in a case where return light as reflected light of the light for detecting the detection object reflected by the detection object enters the light reception element, an electric signal corresponding to intensity of the return light; and a light control mechanism configured to control a transmission range of the light for detecting the detection object, based on a road condition around a vehicle.

### TECHNICAL FIELD

The present disclosure relates to a vehicle lamp, and in particular to a vehicle lamp that can transmit light for detecting a detection object (e.g., preceding vehicle, oncoming vehicle, pedestrian, bicycle, and motorcycle) transmitted from a LiDAR apparatus to an appropriate range based on a road condition around a vehicle.

### BACKGROUND ART

Patent Literature 1 discloses a vehicle lamp that includes a LiDAR apparatus provided so as to be invisible from outside on a front side of the vehicle, and a reflection plate (reflection surface) reflecting light for detecting a detection object (e.g., preceding vehicle, oncoming vehicle, pedestrian, bicycle, and motorcycle) transmitted from the LiDAR apparatus (and return light thereof).

In contrast, the present inventors studied transmission of the light for detecting the detection object (e.g., preceding vehicle, oncoming vehicle, pedestrian, bicycle, and motorcycle) transmitted from the LiDAR apparatus, to an appropriate range based on a road condition around a vehicle (and reception of return light thereof).

### CITATION LIST

### Patent Literature

Patent Literature 1: International Patent Publication No. WO 2019/203177

### SUMMARY OF INVENTION

### Technical Problem

In Patent Literature 1, however, transmission of the light for detecting the detection object (e.g., preceding vehicle, oncoming vehicle, pedestrian, bicycle, and motorcycle) transmitted from the LiDAR apparatus, to an appropriate range based on a road condition around the vehicle (and reception of return light thereof) is not studied at all, and there is room for improvement.

The present disclosure is made to solve such issues, and an object of the present disclosure is to provide a vehicle lamp that can transmit light for detecting a detection object (e.g., preceding vehicle, oncoming vehicle, pedestrian, bicycle, and motorcycle) transmitted from a LiDAR apparatus to an appropriate range based on a road condition around a vehicle (and receive return light thereof).

### Solution to Problem

A vehicle lamp according to the present disclosure includes: a LiDAR apparatus including a light source configured to emit light for detecting a detection object transmitted to a first detection range, and a light reception element configured to output, in a case where return light as reflected light of the light for detecting the detection object reflected by the detection object enters the light reception element, an electric signal corresponding to intensity of the return light; and a light control mechanism configured to control a transmission range of the light for detecting the detection object, based on a road condition around a vehicle.

With such a configuration, it is possible to transmit the light for detecting the detection object (e.g., preceding vehicle, oncoming vehicle, pedestrian, bicycle, and motorcycle) transmitted from the LiDAR apparatus to an appropriate range based on the road condition around the vehicle (and to receive return light thereof).

In the above-described vehicle lamp, the light control mechanism may include a first reflection surface designed to reflect and transmit the light for detecting the detection object emitted from the light source, to a second detection range wider than the first detection range, a second reflection surface, and a first actuator configured to move the second reflection surface to a first position out of an optical path of the light for detecting the detection object reflected by the first reflection surface or a second position on the optical path of the light for detecting the detection object reflected by the first reflection surface, based on the road condition around the vehicle.

In the above-described vehicle lamp, the light control mechanism may include a first reflection surface designed to reflect and transmit the light for detecting the detection object emitted from the light source, to a second detection range wider than the first detection range, and a second actuator configured to change an inclination of the first reflection surface based on the road condition around the vehicle.

In the above-described vehicle lamp, the light control mechanism may include a first reflection surface designed to reflect and transmit the light for detecting the detection object emitted from the light source, to a second detection range wider than the first detection range, and a third actuator configured to change an inclination of the LiDAR apparatus based on the road condition around the vehicle.

In the above-described vehicle lamp, the light control mechanism may include a first reflection surface designed to reflect and transmit the light for detecting the detection object emitted from the light source, to a second detection range wider than the first detection range, and an optical element disposed on an optical path of the light for detecting the detection object reflected by the first reflection surface and configured to be switched to a first state of allowing the light for detecting the detection object reflected by the first reflection surface to pass therethrough or a second state of reflecting the light for detecting the detection object reflected by the first reflection surface, based on the road condition around the vehicle.

### Advantageous Effects of Invention

According to the present disclosure, it is possible to provide the vehicle lamp that can transmit the light for detecting the detection object (e.g., preceding vehicle, oncoming vehicle, pedestrian, bicycle, and motorcycle) transmitted from the LiDAR apparatus to the appropriate range based on the road condition around the vehicle (and receive return light thereof).

### BRIEF DESCRIPTION OF THE DRAWINGS

FIG. 1 is a front view of a vehicle V mounted with vehicle lamps 10 according to a first embodiment.

FIG. 2 is a top view of the vehicle V mounted with the vehicle lamps 10 according to the first embodiment.

FIG. 3A is a side view (cross-sectional view) A of a movable LiDAR apparatus 40.

FIG. 3B is a top view.

FIG. 4A illustrates an example of a slide mechanism 43.

FIG. 4B illustrates an example of the slide mechanism 43.

FIG. 5 illustrates an example (schematic configuration diagram) of the slide mechanism 43.

FIG. 6 is a diagram to explain a forward monitoring mode.

FIG. 7 is a diagram to explain a side monitoring mode.

FIG. 8 is a diagram to explain a side 90-degree monitoring mode.

FIG. 9 is a diagram to explain a side obliquely-rearward monitoring mode.

FIG. 10 is a functional block diagram of a vehicle system 1 controlling the movable LiDAR apparatus 40.

FIG. 11 is a functional block diagram of a LiDAR apparatus 50.

FIG. 12 is a flowchart of an operation example of each of the vehicle lamps 10 (LiDAR apparatus 50).

FIG. 13 is a flowchart of operation of the movable LiDAR apparatus 40.

FIG. 14A is a side view (cross-sectional view) of a movable LiDAR apparatus 40A.

FIG. 14B is a top view.

FIG. 15A is a side view (cross-sectional view) of the movable LiDAR apparatus 40 (modified example).

FIG. 15B is a top view.

FIG. 16A is a side view (cross-sectional view) of the movable LiDAR apparatus 40 (modified example).

FIG. 16B is a top view.

### DESCRIPTION OF EMBODIMENTS

### First Embodiment

Vehicle lamps 10 according to a first embodiment of the present disclosure are described below with reference to accompanying drawings. In the drawings, corresponding components are denoted by the same reference numerals, and repetitive description is omitted.

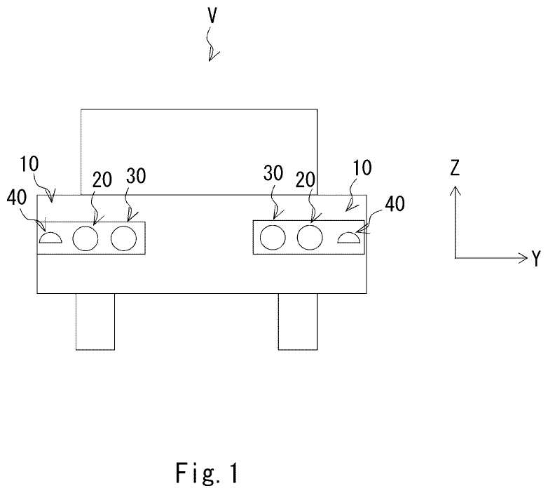

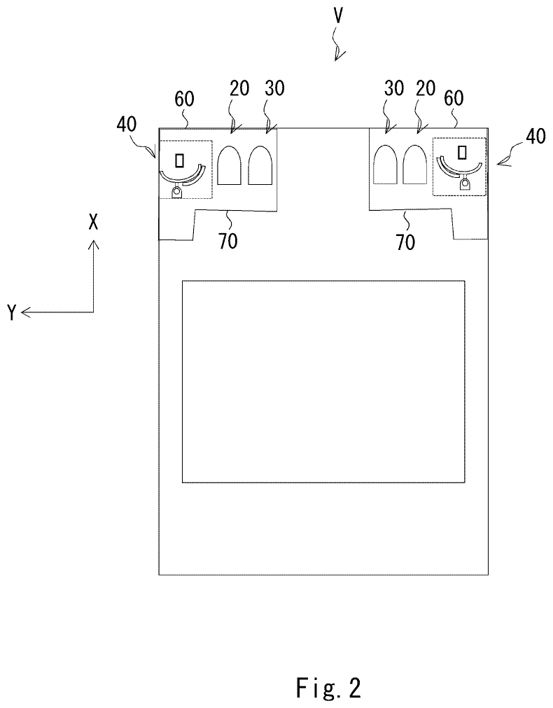

FIG. 1 is a front view of a vehicle V mounted with the vehicle lamps 10 according to the first embodiment, and FIG. 2 is a top view.

The vehicle lamps 10 according to the first embodiment are head lamps with built-in LiDAR (Light Detection And Ranging) apparatuses, and are mounted on both right and left sides at a front end part of the vehicle V such as an automobile.

As illustrated in FIG. 1 and FIG. 2, each of the vehicle lamps 10 includes a low-beam lamp unit 20, a high-beam lamp unit 30, and a movable LiDAR apparatus 40. Each of the vehicle lamps 10 is disposed in a lamp chamber configured by an outer lens 60 and a housing 70, and is fixed to the housing 70 and the like. The vehicle lamps 10 mounted on both right and left sides are configured symmetrically to each other. Therefore, in the following, the movable LiDAR apparatus 40 mounted on the left side (left side in direction toward front side of vehicle) at the front end part of the vehicle Vis described as a representative. As for the low-beam lamp unit 20 and the high-beam lamp unit 30, an existing low-beam lamp unit and an existing high-beam lamp unit are usable. Therefore, description thereof is omitted.

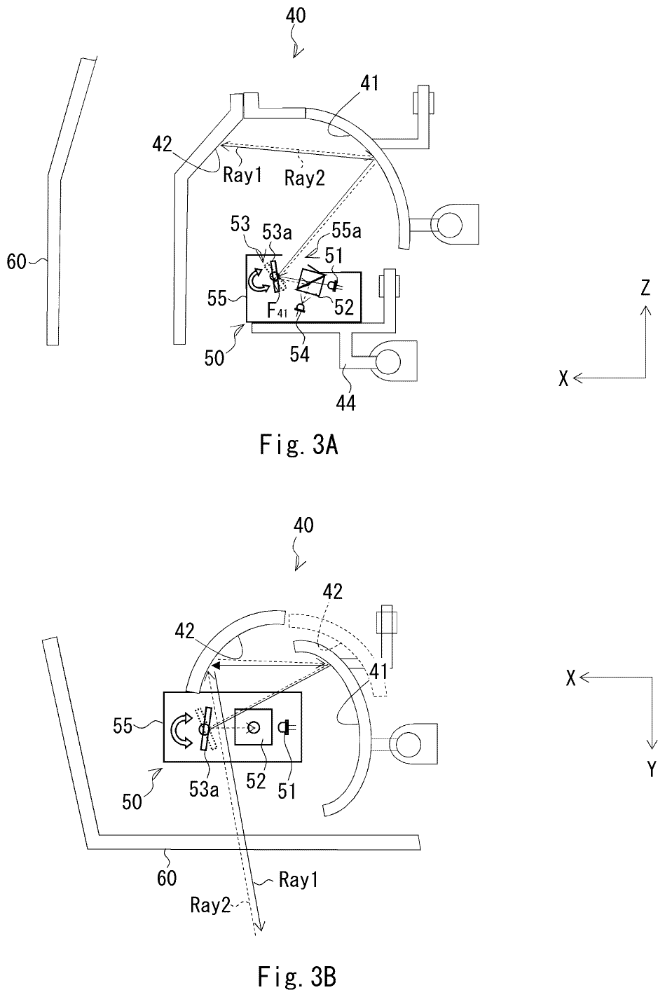

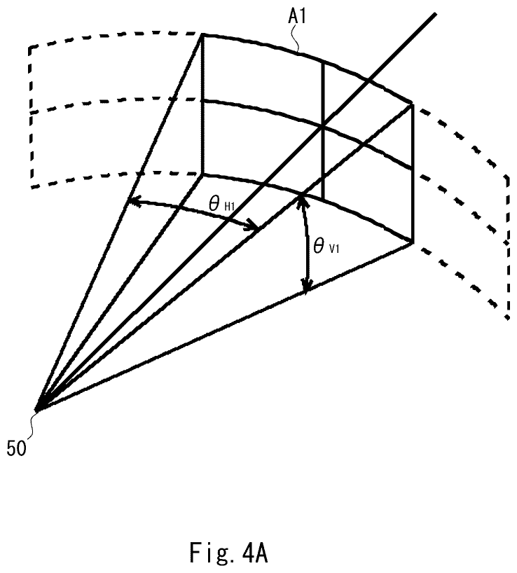

FIG. 3A is a side view (cross-sectional view) of the movable LiDAR apparatus 40, and FIG. 3B is a top view. FIG. 4A and FIG. 4B each illustrate an example of a slide mechanism 43.

As illustrated in FIG. 3A and FIG. 3B, the movable LiDAR apparatus 40 includes a first reflection surface 41, a second reflection surface 42, the slide mechanism 43, and an LiDAR apparatus 50 (LiDAR unit or LiDAR module). In the following, for convenience of description, XYZ axes are defined as illustrated in FIG. 2 and other drawings. The X axis extends in a vehicle front-rear direction. The Y axis extends in a vehicle width direction. The Z axis extends in a vertical direction.

The first reflection surface 41 is designed so as to reflect and transmit laser light Ray1 (light for detecting detection object) transmitted from the LiDAR apparatus 50 (emitted from light source 51) to a second detection range wider than a first detection range. The first detection range and the second detection range are described. FIG. 4A illustrates an example of a (original) detection range (first detection range A1) of the LiDAR apparatus 50 itself, and FIG. 4B illustrates an example of a second detection range A2 wider than the first detection range A1.

The first detection range A1 is a detection range originally possessed by the LiDAR apparatus 50, and is a range of a spread angle θ_{H1} in a horizontal direction (viewing angle in horizontal direction) and a spread angle θ_{V1} in a perpendicular direction (viewing angle in horizontal direction) as illustrated in FIG. 4A. For example, the angle θ_{H1} is 20 degrees to 30 degrees, and the angle θ_{V1} is 1 degree to 10 degrees. For example, a resolution in the horizontal direction is 0.5 degrees, a resolution in the perpendicular direction is 0.5 degrees, and a detection (measurement) distance is 100 m to 200 m. The second detection range A2 is a range of a spread angle θ_{H2} in the horizontal direction (viewing angle in horizontal direction) and a spread angle θ_{V2} in the perpendicular direction (viewing angle in horizontal direction) as illustrated in FIG. 4B. For example, the angle θ_{H2} is 90 degrees to 120 degrees, and the angle θ_{V2} is 1 degree to 10 degrees.

The first reflection surface 41 is, for example, a revolved parabolic reflection surface. For example, a vertical cross-sectional shape of the first reflection surface 41 is a substantially parabolic shape, and a focal point F₄₁ (see FIG. 3A) thereof is positioned near a MEMS mirror 53a. In contrast, a lateral cross-sectional shape of the first reflection surface 41 is not a parabolic shape, and is designed such that the light Ray1 reflected by the first reflection surface 41 is diffused in the horizontal direction. For example, a radius of curvature of the lateral cross-sectional shape of the first reflection surface 41 is designed so as to be greater than a radius of curvature of the vertical cross-sectional shape of the first reflection surface 41. Therefore, the light Ray1 transmitted from the LiDAR apparatus 50 to the range of the spread angle θ_{H1} in the horizontal direction (see FIG. 4B) is reflected by the first reflection surface 41, is thereby diffused to the range of the spread angle θ_{H2} in the horizontal direction (see FIG. 4B), and is applied forward. The first reflection surface 41 may be a free-form surface, or may include a plurality of reflection regions formed by dividing the first reflection surface 41 (e.g., in lattice shape). Each of the reflection regions is designed as a convex surface or a concave surface so as to diffuse the light Ray 1 reflected by each of the reflection regions in the horizontal direction (so-called multi-reflector).

The second reflection surface 42 is a movable reflection surface slid by the slide mechanism 43. The second reflection surface 42 may be a plane reflection surface or a curved reflection surface.

The slide mechanism 43 is an example of a light control mechanism that controls a transmission range (transmission direction) of the laser light Ray 1 based on a road condition around the vehicle V.

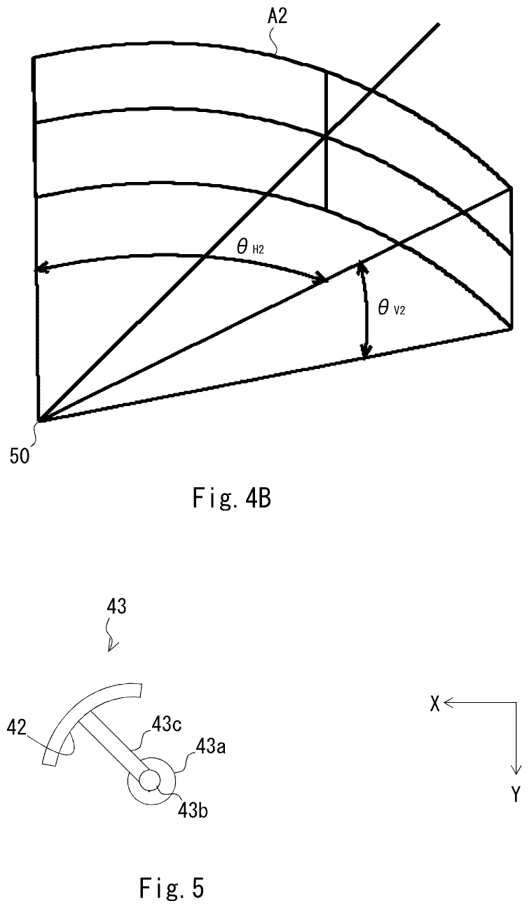

FIG. 5 illustrates an example (schematic configuration diagram) of the slide mechanism 43.

As illustrated in FIG. 5, the slide mechanism 43 includes a motor 43a (example of first actuator according to present disclosure), and a joint 43c coupling a rotary shaft 43b of the motor 43a and the second reflection surface 42. The rotary shaft 43b of the motor 43a extends in the Z-axis direction.

A control unit 90 (light control unit 93) described below controls the motor 43a to slide the second reflection surface around the rotary shaft 43b. This makes it possible to change the transmission range of the light Ray1 reflected by the first reflection surface 41.

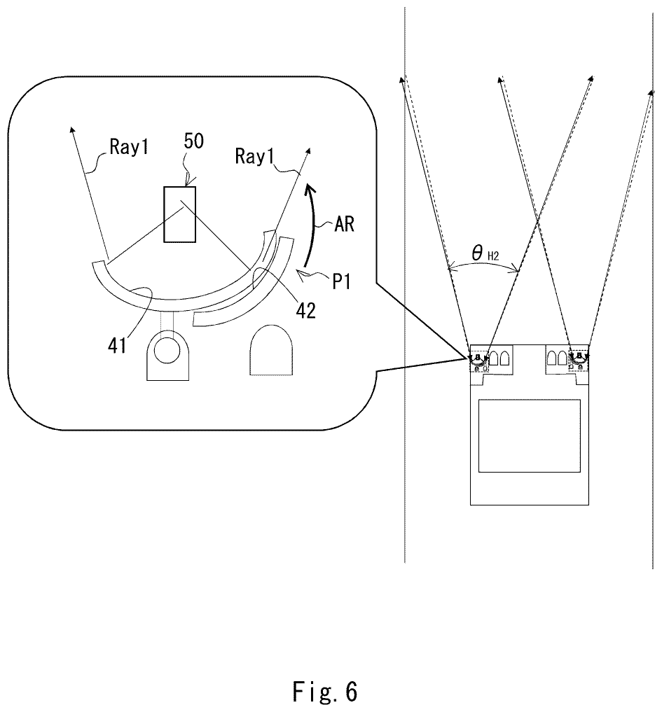

For example, as illustrated in FIG. 6, when the second reflection surface 42 is disposed at a retreat position P1 (example of first position according to present disclosure) behind the first reflection surface 41, the light Ray1 reflected by the first reflection surface 41 can be transmitted to a range of the angle θ_{H2} in front of the vehicle. In the following, the mode is referred to as a forward monitoring mode. FIG. 6 is a diagram to explain the forward monitoring mode.

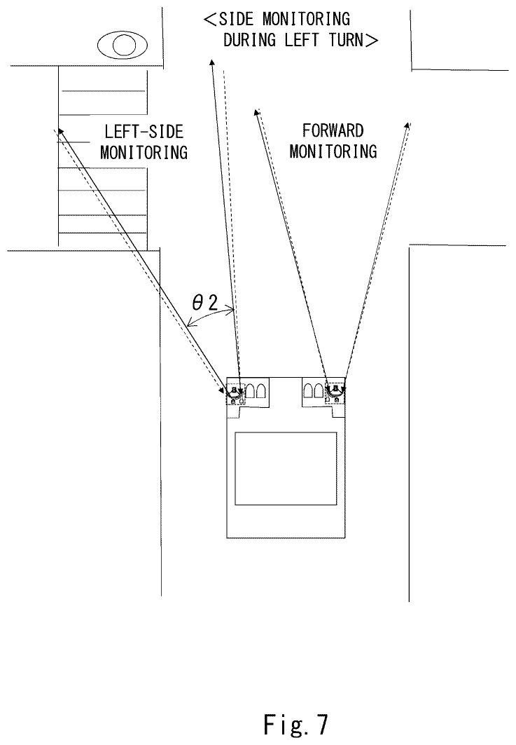

For example, when the second reflection surface 42 is slid by a first distance from the retreat position P1 in a direction of an arrow AR (see FIG. 6) and is (partially) disposed at a position (not illustrated, example of second position according to present disclosure) on an optical path of the light Ray1 reflected by the first reflection surface 41, the light Ray1 reflected by the first reflection surface 41 and the second reflection surface 42 can be transmitted to a range of an angle θ2 on a side of the vehicle as illustrated in FIG. 7. In the following, the mode is referred to as a side monitoring mode. FIG. 7 is a diagram to explain the side monitoring mode.

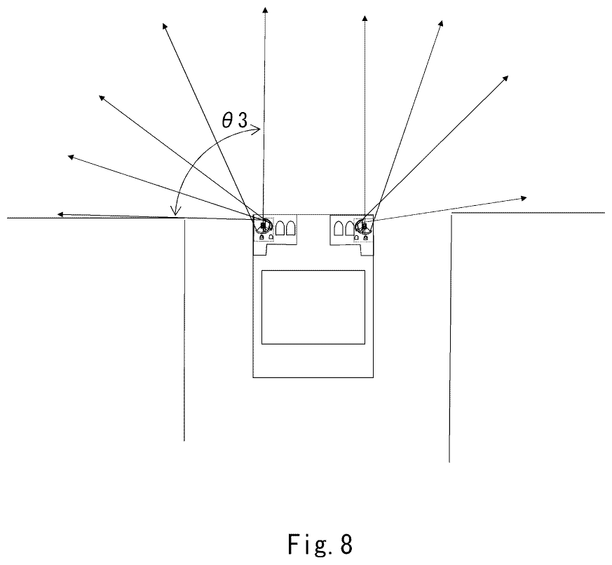

For example, when the second reflection surface 42 is slide by a second distance (second distance>first distance) from the retreat position P1 in the direction of the arrow AR (see FIG. 6) and is (partially) disposed on a position (not illustrated, another example of second position according to present disclosure) on the optical path of the light Ray1 reflected by the first reflection surface 41, the light Ray1 reflected by the first reflection surface 41 and the second reflection surface 42 can be transmitted to a range of an angle θ3 on the side of the vehicle as illustrated in FIG. 8. In the following, the mode is referred to as a side 90-degree monitoring mode. FIG. 8 is a diagram to explain the side 90-degree monitoring mode.

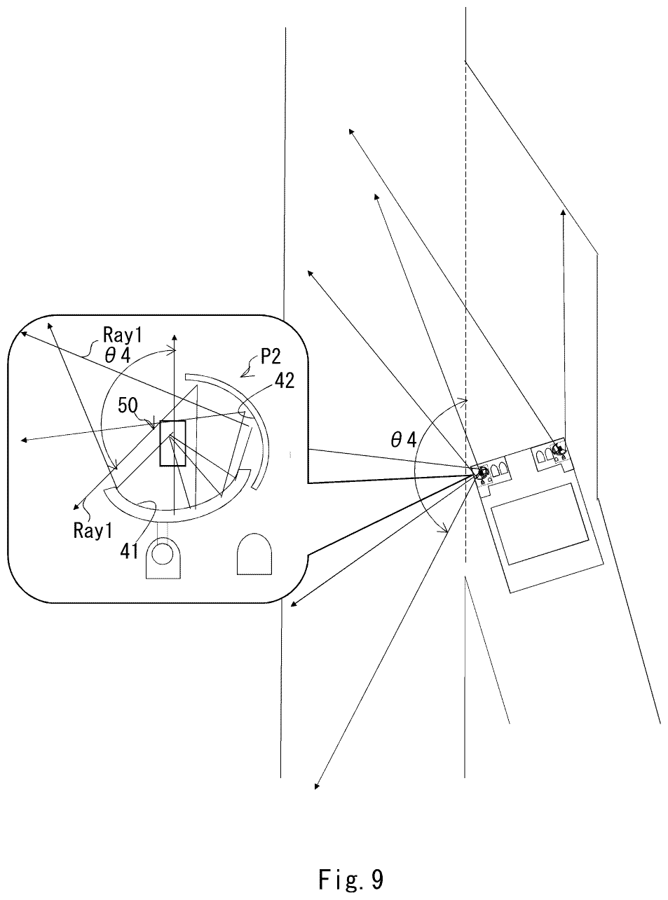

For example, as illustrated in FIG. 9, when the second reflection surface 42 is slid by a third distance (third distance>second distance) from the retreat position P1 in the direction of the arrow AR (see FIG. 6) and is (partially) disposed on a position P2 (still another example of second position according to present disclosure) on the optical path of the light Ray1 reflected by the first reflection surface 41, the light Ray1 reflected by the first reflection surface 41 and the second reflection surface 42 can be transmitted to a range of an angle θ4 from a front side to a rear side of the vehicle. In the following, the mode is referred to as a side obliquely-rearward monitoring mode. FIG. 9 is a diagram to explain the side obliquely-rearward monitoring mode.

The LiDAR apparatus 50 has a function of transmitting (applying) the laser light that is the light for detecting a detection object (e.g., preceding vehicle, oncoming vehicle, pedestrian, bicycle, and motorcycle) to the first detection range A1 (detection range originally possessed by LiDAR apparatus 50, see FIG. 4A), a function of receiving return light that is reflected light of the laser light reflected by the detection object, and a function of measuring a distance to a measurement object based on a time from transmission of the laser light until reception of the return light. As illustrated in FIG. 3A, the LiDAR apparatus 50 includes a light source 51, a beam splitter 52, a light deflector 53 (MEMS mirror 53a), a light reception element 54, and a case 55 housing these components. A lens collecting (collimating) the laser light emitted from the light source 51 may be provided between the light source 51 and the beam splitter 52. The case 55 is formed with an opening portion 55a through which the laser light emitted from the light source 51 and the return light thereof pass. As the LiDAR apparatus 50, for example, a LiDAR apparatus disclosed in International Publication No. WO 2020/145095 is usable.

The light source 51 is a semiconductor light emitting element such as a laser diode (LD) emitting laser light. The laser light emitted from the light source 51 is an example of the light for detecting the detection object (for scanning first detection range A1) transmitted (applied) to the first detection range A1 (detection range originally possessed by LiDAR apparatus 50, see FIG. 4A). In the following, the laser light emitted from the light source 51 is referred to as the laser light Ray1. The return light that is reflected light of the laser light Ray 1 reflected by the detection object is referred to as return light Ray2. The light emitted from the light source 51 is, for example, an infrared ray having a wavelength of 905 nm to 1500 nm. The light source 51 emits the laser light Ray1 (in form of pulses) under the control of a light source control unit 50a.

The laser light Ray1 emitted from the light source 51 passes through the beam splitter 52, and enters the light deflector 53 (MEMS mirror 53a).

The light deflector 53 includes the MEMS mirror 53a that reflects the laser light Ray1 so as to two-dimensionally (in horizontal direction and perpendicular direction) scan the first detection range A1 (see FIG. 4A) with the laser light Ray1. The MEMS mirror 53a is swung around two axes (e.g., horizontal axis and perpendicular axis) orthogonal to each other under the control of a mirror control unit 50b described below, so as to two-dimensionally (in horizontal direction and perpendicular direction) scan the first detection range A1 (see FIG. 4A) with the laser light Ray1 entering and reflected by the MEMS mirror 53a.

As a result, the laser light Ray1 that has been emitted from the light source 51, passed through the beam splitter 52, and entered the light deflector 53 (MEMS mirror 53a) is transmitted (applied) to the first detection range A1 (see FIG. 4A) (performs two-dimensional scanning of first detection range A1).

The return light Ray2 that is the reflected light of the laser light Ray1 reflected by the detection object returns to the LiDAR apparatus 50 through the optical path same as the optical path of the laser light Ray1, is divided (reflected) toward the light reception element 54 by the beam splitter 52, and enters the light reception element 54. In FIG. 3A, FIG. 3B, and other drawings, the return light Ray2 is drawn as a dotted arrow deviated from the laser light Ray1 for facilitating understanding; however, the optical path of the return light Ray2 and the optical path of the laser light Ray1 are actually coincident with each other.

When the return light Ray2 that is the reflected light of the laser light Ray 1 reflected by the detection object enters the light reception element 54, the light reception element 54 outputs an electric signal corresponding to intensity of the return light Ray2. The light reception element 54 is, for example, a photodiode or a SPAD (Single Photon Avalanche Diode). The electric signal output from the light reception element 54 is input to a signal processing unit 50c described below.

The LiDAR apparatus 50 (case 55) having the above-described configuration is fixed to a housing or the like through a bracket 44 in a state where the opening portion 55a through which the laser light Ray1 and the return light Ray2 thereof pass is directed upward (see FIG. 3B).

In the movable LiDAR apparatus 40 having the above-described configuration, the laser light Ray1 emitted from the light source 51 passes through the beam splitter 52, is reflected by the light deflector 53 (MEMS mirror 53a), and is further reflected by the first reflection surface 41 (or first reflection surface 41 and second reflection surface 42). As a result, the laser light Ray1 is increased in emission angle (in particular, emission angle in horizontal direction), and is transmitted (applied) to the second detection range A2 (see FIG. 4B) wider than the first detection range A1 (detection range originally possessed by LiDAR apparatus 50, see FIG. 4A) (performs two-dimensional scanning of second detection range A2).

Next, a configuration example of a vehicle system 1 controlling the movable LiDAR apparatus 40 is described.

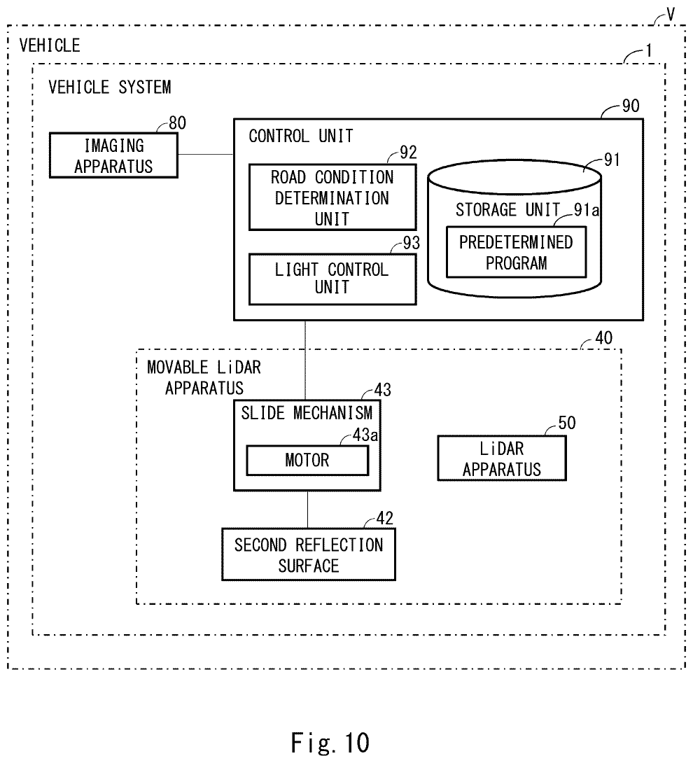

FIG. 10 is a functional block diagram of the vehicle system 1 controlling the movable LiDAR apparatus 40.

As illustrated in FIG. 10, the vehicle system 1 includes an imaging apparatus 80 and a control unit 90.

The imaging apparatus 80 includes an imaging element such as a CCD sensor and a CMOS sensor imaging the front side of the vehicle V. The imaging apparatus 80 is provided at a predetermined position (e.g., in cabin) of the vehicle V. An image of the periphery of the vehicle V (e.g., image of front side of vehicle V, image data) captured by the imaging apparatus 80 is input to the control unit 90.

The control unit 90 includes, for example, a processor (not illustrated). The processor is, for example, a CPU (Central Processing Unit). One processor or a plurality of processors are provided depending on a case. The processor executes a predetermined program 91a read from a nonvolatile storage unit 91 such as a flash ROM to a memory (not illustrated), thereby functioning as a road condition determination unit 92 and the light control unit 93. A part or all of these units may be realized by hardware.

The road condition determination unit 92 determines a road condition (e.g., straight road, intersection, three-forked road, and junction) around the vehicle V by performing predetermined image processing based on, for example, the image (image data) captured by the imaging apparatus 80. The road condition determination unit 92 may determine the road condition around the vehicle V based on data input from a navigation apparatus (not illustrated) and the like mounted on the vehicle V.

The light control unit 93 controls the motor 43a configuring the slide mechanism 43 based on the road condition around the vehicle V that is a determination result of the road condition determination unit 92, thereby moving the second reflection surface 42. The light control unit 93 thus controls the transmission range (transmission direction) of the laser light Ray1 based on the road condition around the vehicle V. A specific example of the control is described below.

Next, functions of the LiDAR apparatus 50 are described.

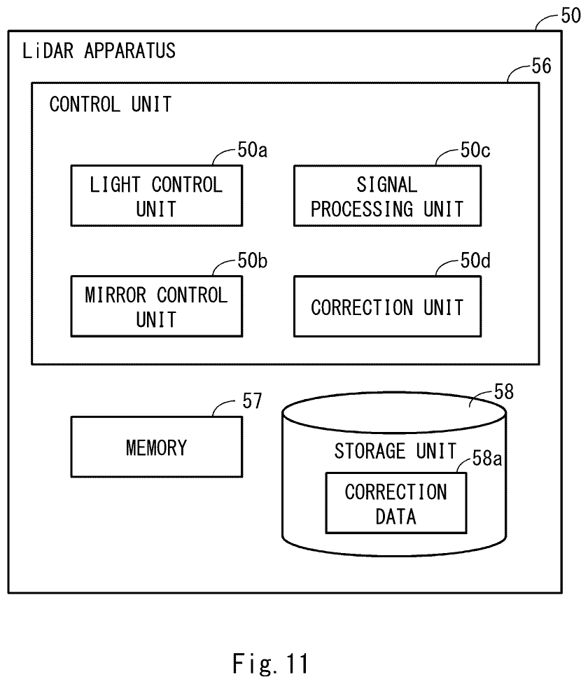

FIG. 11 is a functional block diagram of the LiDAR apparatus 50.

As illustrated in FIG. 11, the LiDAR apparatus 50 includes a control unit 56, a memory 57, and a storage unit 58. The control unit 56 includes, for example, a processor (not illustrated). The processor is, for example, a CPU (Central Processing Unit). One processor or a plurality of processors are provided depending on a case. The processor executes a predetermined program (not illustrated) read from the nonvolatile storage unit 58 such as a flash ROM to the memory 57 (e.g., RAM), thereby functioning as the light source control unit 50a, the mirror control unit 50b, the signal processing unit 50c, and a correction unit 50d. A part or all of these units may be realized by hardware.

The light source control unit 50a controls the light source 51 to emit light in a form of pulses.

The mirror control unit 50b controls the light deflector 53 (MEMS mirror 53a) so as to two-dimensionally (in horizontal direction and perpendicular direction) scan the first detection range A1 (detection range originally possessed by LiDAR apparatus 50, see FIG. 4A), for example, measurement points (e.g., N_{H} measurement points in horizontal direction and N_{V} measurement points in perpendicular direction) in the first detection range A1, with the laser light Ray1 that enters and is reflected by the MEMS mirror 53a.

The signal processing unit 50c calculates, for each of the measurement points, a distance (distance to each of measurement points) associated with an angle direction of the detection object (e.g., azimuth and elevation angle of each of measurement points) based on a time from transmission of the laser light Ray 1 until reception of the return light Ray2 and the like, and outputs the angle direction of the detection object (e.g., azimuth and elevation angle of each of measurement points) and the distance (distance to each of measurement points). The output angle direction of the detection object (e.g., azimuth and elevation angle of each of measurement points) is corrected by the correction unit 50d in a manner described below. Thereafter, the corrected angle direction is stored together with the distance (distance to each of the measurement points) in the memory 57 or the storage unit 58, and is used to detect the detection object (e.g., preceding vehicle, oncoming vehicle, pedestrian, bicycle, and motorcycle).

The correction unit 50d corrects the angle direction of the detection object (e.g., azimuth and elevation angle of each of measurement points) output from the signal processing unit 50c, based on correction data 58a. The correction data 58a is stored in, for example, the storage unit 58.

Technical significance in correcting the angle direction of the detection object (e.g., azimuth and elevation angle of each of measurement points) is as follows. The laser light Ray1 that enters and is reflected by the MEMS mirror 53a is reflected by the first reflection surface 41 (or first reflection surface 41 and second reflection surface 42). Therefore, the laser light Ray1 is actually transmitted not into the first detection range A1 (detection range originally possessed by LiDAR apparatus 50, see FIG. 4A) but to the second detection range A2 (see FIG. 4B) wider than the first detection range A1.

Therefore, for example, the laser light Ray1 to be transmitted to a specific angle direction (e.g., azimuth θ and specific elevation angle φ) is reflected by the first reflection surface 41 (or first reflection surface 41 and second reflection surface 42), and is accordingly actually transmitted to an angle direction (e.g., azimuth θ+Δθ and elevation angle φ+Δφ) different from the specific angle direction (e.g., azimuth θ and specific elevation angle φ).

Therefore, the correction unit 50d corrects the specific angle direction (e.g., azimuth θ and elevation angle φ) output from the signal processing unit 50c to the azimuth θ+Δθ and the elevation angle φ+Δφ based on the correction data. A0 and Δφ are examples of the correction data. The correction data (Δθ and Δφ) can be previously calculated by tracking a light beam for each angle direction (e.g., azimuth and elevation angle) by using, for example, predetermined simulation software, and stored in the storage unit 58.

Next, an operation example of each of the vehicle lamps 10 (LiDAR apparatus 50) is described.

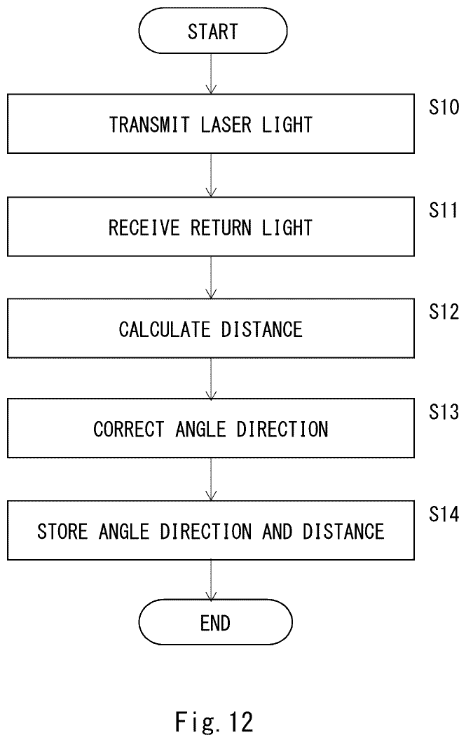

FIG. 12 is a flowchart of an operation example of each of the vehicle lamps (LiDAR apparatus 50).

First, the laser light Ray1 is transmitted (step S10). This is realized when the light source control unit 50a controls the light source 51 to emit light in a form of pulses. The laser light Ray1 emitted from the light source 51 passes through the beam splitter 52, is reflected by the light deflector 53 (MEMS mirror 53a), and is further reflected by the first reflection surface 41 (or first reflection surface 41 and second reflection surface 42). As a result, the laser light Ray1 is increased in emission angle (in particular, emission angle in horizontal direction), and is transmitted (applied) to the second detection range A2 (see FIG. 4B) wider than the first detection range A1 (detection range originally possessed by LiDAR apparatus 50, see FIG. 4A) (performs two-dimensional scanning of second detection range A2).

Next, the return light Ray2 is received (step S11). The return light Ray2 that is reflected light of the laser light Ray1 transmitted in step S10 and reflected by the detection object returns to the LiDAR apparatus 50 through the optical path same as the optical path of the laser light Ray1, is divided (reflected) toward the light reception element 54 by the beam splitter 52, and enters the light reception element 54. In a case where the return light Ray2 enters the light reception element 54, the light reception element 54 outputs an electric signal corresponding to intensity of the return light Ray2.

Next, the distance to the detection object is calculated (step S12). This is realized by the signal processing unit 50c. The signal processing unit 50c calculates, for each of the measurement points, a distance (distance to each of measurement points) associated with an angle direction of the detection object (e.g., azimuth and elevation angle of each of measurement points) based on a time from transmission of the laser light Ray1 until reception of the return light Ray2 and the like, and outputs the angle direction of the detection object (e.g., azimuth and elevation angle of each of measurement points) and the distance (distance to each of measurement points).

Next, the angle direction of the detection object (e.g., azimuth and elevation angle of each of measurement points) output from the signal processing unit 50c in step S12 is corrected (step S13). This is realized by the correction unit 50d. The correction unit 50d corrects the angle direction of the detection object (e.g., azimuth and elevation angle of each of measurement points) output from the signal processing unit 50c in step S12, based on the correction data 58a.

Next, the angle direction of the detection object (e.g., azimuth and elevation angle of each of measurement points) corrected in step S13 and the distance calculated in step S12 are stored in the memory 57 or the storage unit 58. The stored angle direction of the detection object and the stored distance are used to detect the detection object (e.g., preceding vehicle, oncoming vehicle, pedestrian, bicycle, and motorcycle).

Next, an example of operation of the movable LiDAR apparatus 40 is described.

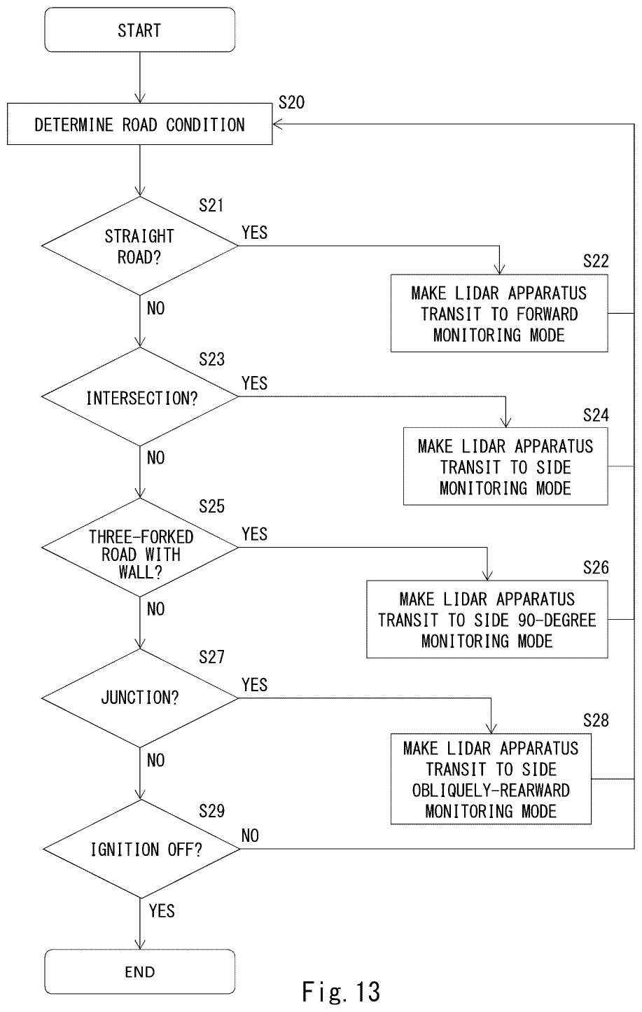

FIG. 13 is a flowchart of the operation of the movable LiDAR apparatus 40.

In the following, as a premise, it is assumed that the vehicle V travels on a straight road (general load, expressway, etc.), and the second reflection surface 42 is disposed at the retreat position P1 (see FIG. 6). Further, it is assumed that the imaging apparatus 80 successively captures images of the periphery of the vehicle V (e.g., image of front side of vehicle V).

First, the road condition around the vehicle V is determined from the image data of the imaging apparatus 80 (step S20). This is realized by the road condition determination unit 92.

In a case where the road condition around the vehicle V is determined as a straight road as a result of the determination in step S20 (step S21: YES), the movable LiDAR apparatus 40 transits to the forward monitoring mode (see FIG. 6) (step S22). More specifically, the light control unit 93 controls the motor 43a configuring the slide mechanism 43, to dispose the second reflection surface 42 at the retreat position P1 (example of first position according to present disclosure) behind the first reflection surface 41. In the forward monitoring mode (see FIG. 6), the light Ray1 reflected by the first reflection surface 41 can be transmitted to the range of the angle θ_{H2} in front of the vehicle.

In a case where the road condition around the vehicle V is determined as an intersection as a result of the determination in step S20 (step S23: YES), the movable LiDAR apparatus 40 transits to the side monitoring mode (see FIG. 7) (step S24). More specifically, the light control unit 93 controls the motor 43a configuring the slide mechanism 43, to slide the second reflection surface 42 by the first distance from the retreat position P1 in the direction of the arrow AR (see FIG. 6), and (partially) disposes the second reflection surface 42 at a position (not illustrated, example of second position according to present disclosure) on the optical path of the light Ray1 reflected by the first reflection surface 41. In the side monitoring mode (see FIG. 7), the light Ray1 reflected by the first reflection surface 41 and the second reflection surface 42 can be transmitted to the range of the angle θ2 on the side of the vehicle as illustrated in FIG. 7.

In a case where the road condition around the vehicle V is determined as a three-forked road (three-forked road with wall) as a result of the determination in step S20 (step S25: YES), the movable LiDAR apparatus 40 transits to the side 90-degree monitoring mode (see FIG. 8) (step S26). More specifically, the light control unit 93 controls the motor 43a configuring the slide mechanism 43, to slide the second reflection surface 42 by the second distance (second distance>first distance) from the retreat position P1 in the direction of the arrow AR (see FIG. 6), and (partially) disposes the second reflection surface 42 at a position (not illustrated, another example of second position according to present disclosure) on the optical path of the light Ray1 reflected by the first reflection surface 41. In the side 90-degree monitoring mode (see FIG. 8), the light Ray 1 reflected by the first reflection surface 41 and the second reflection surface 42 can be transmitted to the range of the angle θ3 on the side of the vehicle as illustrated in FIG. 8.

In a case where the road condition around the vehicle V is determined as a junction (junction of expressway) as a result of the determination in step S20 (step S27: YES), the movable LiDAR apparatus 40 transits to the side obliquely-rearward monitoring mode (see FIG. 9) (step S26). More specifically, the light control unit 93 controls the motor 43a configuring the slide mechanism 43, to slide the second reflection surface 42 by the third distance (third distance>second distance) from the retreat position P1 in the direction of the arrow AR (see FIG. 6), and (partially) disposes the second reflection surface 42 at the position P2 (another example of second position according to present disclosure) on the optical path of the light Ray1 reflected by the first reflection surface 41 as illustrated in FIG. 9. In the side obliquely-rearward monitoring mode (see FIG. 9), the light Ray1 reflected by the first reflection surface 41 and the second reflection surface 42 can be transmitted to the range of the angle θ4 from the front side to the rear side of the vehicle.

The above-described processing in steps S20 to S28 is repeatedly performed until ignition is turned off (step S29: YES).

As described above, according to the first embodiment, the laser light Ray 1 transmitted from the LiDAR apparatus 50 can be transmitted to the appropriate range based on the road condition around the vehicle V (and return light thereof can be received).

This can be achieved because the slide mechanism 43 (motor 43a) that moves the second reflection surface 42 to the first position P1 (e.g., see FIG. 6) out of the optical path of the laser light Ray1 reflected by the first reflection surface 41 or the second position P2 (e.g., see FIG. 9) on the optical path of the laser light Ray1 reflected by the first reflection surface 41 based on the road condition around the vehicle V, and the light control unit 93 that controls the slide mechanism 43 (motor 43a) based on the road condition around the vehicle V as the determination result of the road condition determination unit 92, are provided.

Further, according to the first embodiment, since the laser light Ray1 emitted from the light source 51 (laser light Ray1 scanned by the MEMS mirror 53a) is transmitted to the second detection range A2 (see FIG. 4B) wider than the first detection range A1 (detection range originally possessed by the LiDAR apparatus 50, see FIG. 4A) by being reflected by the first reflection surface 41 (or first reflection surface 41 and second reflection surface 42), it is possible to expand (in particular, in horizontal direction) the detection range (first detection range A1) originally possessed by the LiDAR apparatus 50 to the second detection range A2.

Further, according to the first embodiment, the correction unit 50d that corrects the angle direction of the detection object (e.g., azimuth and elevation angle of each of measurement points) output from the signal processing unit 50c based on the correction data 58a is provided. Therefore, even when the detection range (first detection range A1) originally possessed by the LiDAR apparatus 50 is expanded to the second detection range A2 as described above, the detection object can be appropriately detected.

Modified examples are described next.

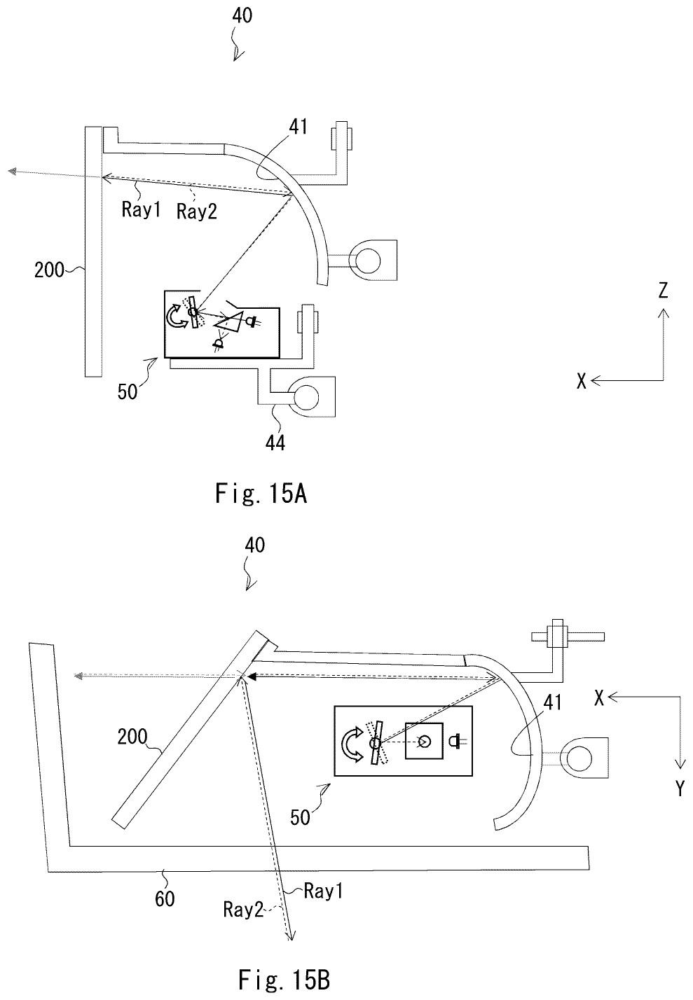

FIG. 15A is a side view (cross-sectional view) of the movable LiDAR apparatus 40 (modified example), and FIG. 15B is a top view.

In the above-described first embodiment, the second reflection surface 42 as the movable reflection surface and the slide mechanism 43 that slides the second reflection surface 42 are used; however, the configuration is not limited thereto. For example, as illustrated in FIG. 15A and FIG. 15B, the second reflection surface 42 as the movable reflection surface and the slide mechanism 43 that slides the second reflection surface 42 may be omitted, and an optical element 100 that is switched to a first state of allowing the laser light Ray1 reflected by the first reflection surface 41 to pass therethrough or a second state of reflecting the laser light Ray1 reflected by the first reflection surface 41, based on the road condition around the vehicle V may be disposed on the optical path of the laser light Ray 1 reflected by the first reflection surface 41. For example, three optical elements 100 may be disposed in series at different angles in correspondence with the side monitoring mode, the side 90-degree monitoring mode, and the side obliquely-rearward monitoring mode. As such an optical element 100, for example, an optical element disclosed in Japanese Unexamined Patent Application Publication No. 2020-177092 is usable.

The present modified example can also achieve effects similar to the effects by the above-described first embodiment.

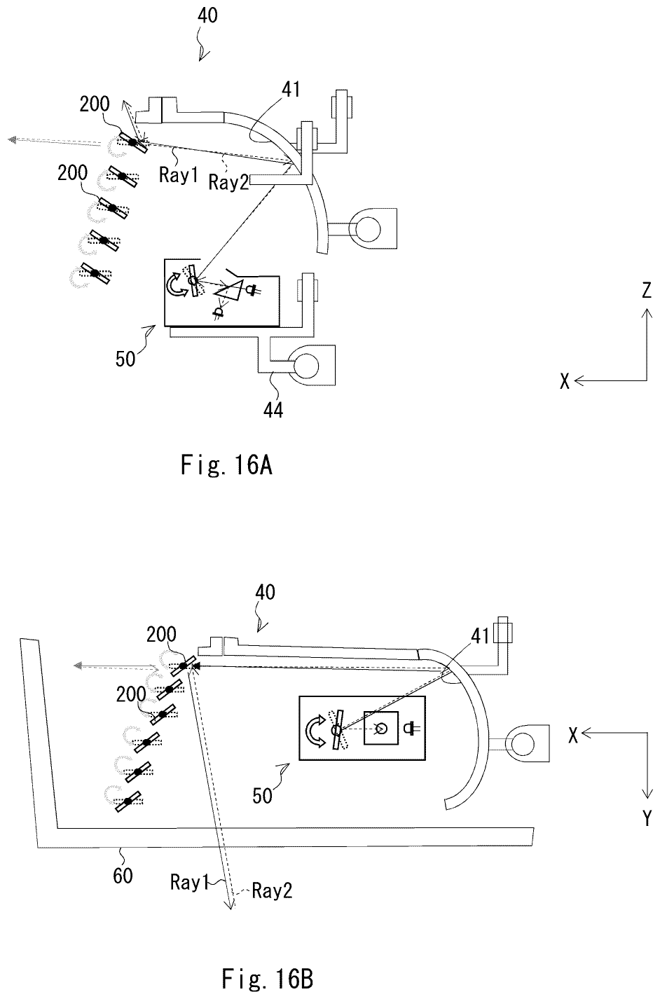

FIG. 16A is a side view (cross-sectional view) of the movable LiDAR apparatus 40 (modified example), and FIG. 16B is a top view.

As illustrated in FIG. 16A and FIG. 16B, the second reflection surface 42 as the movable reflection surface and the slide mechanism 43 sliding the second reflection surface 42 may be omitted, and a plurality of reflection mirrors 200, a rotation amount of each of which is controlled based on the road condition around the vehicle V, may be disposed in a form of a shutter on the optical path of the laser light Ray1 reflected by the first reflection surface 41. Rotary shafts of the reflection mirrors 200 extend in a direction (Z-axis direction) orthogonal to a paper surface in FIG. 16B.

The present modified example can also achieve effects similar to the effects by the above-described first embodiment.

### Second Embodiment

As a second embodiment of the present disclosure, a movable LiDAR apparatus 40A is described with reference to accompanying drawings. In the drawings, corresponding components are denoted by the same reference numerals, and repetitive description is omitted.

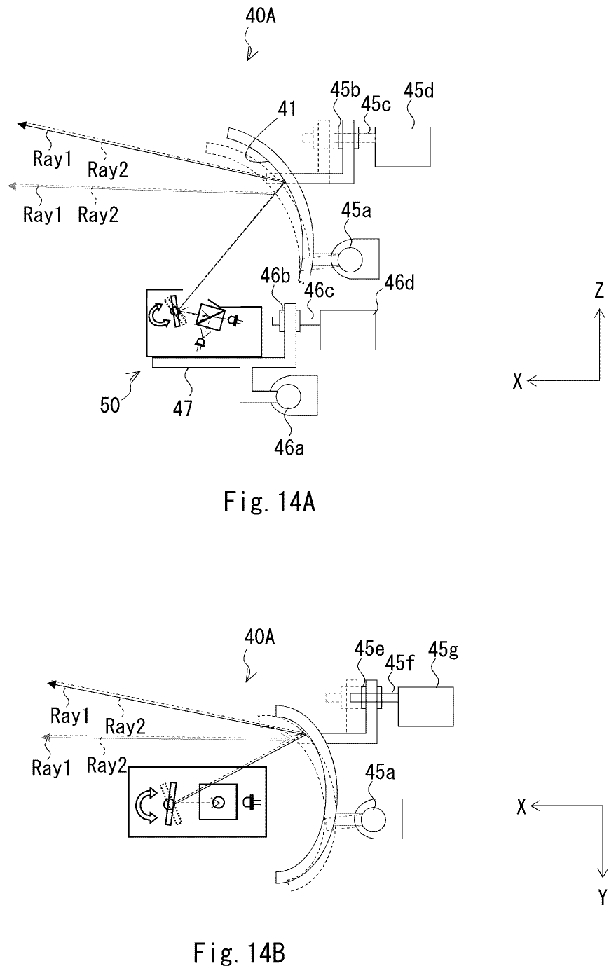

FIG. 14A is a side view (cross-sectional view) of the movable LiDAR apparatus 40A, and FIG. 14B is a top view.

In comparison with the movable LiDAR apparatus 40 according to the first embodiment, the movable LiDAR apparatus 40A according to the second embodiment has a configuration similar to the configuration of the movable LiDAR apparatus 40 according to the first embodiment except for points described below. In the following, differences from the movable LiDAR apparatus 40 according to the first embodiment are mainly described, the configuration similar to the configuration of the movable LiDAR apparatus 40 according to the first embodiment is denoted by the same reference numeral, and description of the configuration is appropriately omitted.

First, the movable LiDAR apparatus 40 according to the first embodiment includes the second reflection surface 42, whereas the second reflection surface 42 is omitted in the movable LiDAR apparatus 40A according to the second embodiment.

Secondly, the movable LiDAR apparatus 40 according to the first embodiment includes the slide mechanism 43 as the light control mechanism controlling the transmission range (transmission direction) of the laser light Ray 1 based on the road condition around the vehicle V, whereas the movable LiDAR apparatus 40A according to the second embodiment includes a mechanism changing an inclination of the first reflection surface 41 based on the road condition around the vehicle V as the light control mechanism controlling the transmission range (transmission direction) of the laser light Ray1 based on the road condition around the vehicle V. For example, the mechanism is configured as follows.

That is, as illustrated in FIG. 14A, the first reflection surface 41 is supported so as to be tiltable in an up-down direction and a right-left direction with a pivot 45a as a fulcrum. The movable LiDAR apparatus 40A includes a first aiming nut 45b provided above the pivot 45a (fulcrum), a first aiming screw 45c screwed to the first aiming nut 45b, and a motor 45d that is a second actuator normally and reversely rotating the first aiming screw 45c and is controlled by the control unit 90 (light control unit 93).

As illustrated in FIG. 14B, the movable LiDAR apparatus 40A further includes a second aiming nut 45e provided on a side of the pivot 45a (fulcrum), a second aiming screw 45f screwed to the second aiming nut 45e, and a motor 45g that is a second actuator normally and reversely rotating the second aiming screw 45f and is controlled by the control unit 90 (light control unit 93).

The movable LiDAR apparatus 40A according to the second embodiment includes a mechanism changing an inclination of the LiDAR apparatus 50 based on the road condition around the vehicle V, as the light control mechanism controlling the transmission range (transmission direction) of the laser light Ray1 based on the road condition around the vehicle V. For example, the mechanism is configured as follows.

As illustrated in FIG. 14A, the LiDAR apparatus 50 is supported through a bracket 47 so as to be tiltable in the up-down direction and the right-left direction with a pivot 46a as a fulcrum. The movable LiDAR apparatus 40A further includes a third aiming nut 46b provided above the pivot 46a (fulcrum), a third aiming screw 46c screwed to the third aiming nut 46b, and a motor 46d that is a second actuator normally and reversely rotating the third aiming screw 46c and is controlled by the control unit 90 (light control unit 93).

Although not illustrated, as with the illustration in FIG. 14B, the movable LiDAR apparatus 40A further includes a fourth aiming nut provided on a side of the pivot 46a (fulcrum), a fourth aiming screw screwed to the fourth aiming nut, and a motor that is a fourth actuator normally and reversely rotates the fourth aiming screw and is controlled by the control unit 90 (light control unit 93).

The control unit 90 (light control unit 93) controls the motors 45d and 45g to tilt the first reflection surface 41 in the up-down direction and the right-left direction around the pivot 45a, which makes it possible to change the transmission range of the light Ray1 reflected by the first reflection surface 41. Likewise, the control unit 90 (light control unit 93) controls the motor 46d and the like to tilt the LiDAR apparatus 50 in the up-down direction and the right-left direction around the pivot 45a, which makes it possible to change the transmission range of the light Ray1 reflected by the first reflection surface 41.

For example, by tilting at least one of the first reflection surface 41 and the LiDAR apparatus 50 by a predetermined amount, the light Ray1 reflected by the first reflection surface 41 can be transmitted to the range of the angle θ_{H2} in front of the vehicle as illustrated in FIG. 6 (forward monitoring mode).

For example, by tilting at least one of the first reflection surface 41 and the LiDAR apparatus 50 by a predetermined amount, the light Ray1 reflected by the first reflection surface 41 can be transmitted to the range of the angle θ2 on the side of the vehicle as illustrated in FIG. 7 (side monitoring mode).

For example, by tilting at least one of the first reflection surface 41 and the LiDAR apparatus 50 by a predetermined amount, the light Ray1 reflected by the first reflection surface 41 can be transmitted to the range of the angle θ3 on the side of the vehicle as illustrated in FIG. 8 (side 90-degree monitoring mode).

For example, by tilting at least one of the first reflection surface 41 and the LiDAR apparatus 50 by a predetermined amount, the light Ray1 reflected by the first reflection surface 41 can be transmitted to the range of the angle θ4 from the front side to the rear side of the vehicle (side obliquely-rearward monitoring mode).

The movable LiDAR apparatus 40A according to the second embodiment can also perform operation similar to the operation in the flowchart illustrated in FIG. 13. In FIG. 13, in a case where the processing in steps S27 and S28 is omitted, only the mechanism changing the inclination of the first reflection surface 41 based on the road condition around the vehicle V may be used, and the mechanism changing the inclination of the LiDAR apparatus 50 based on the road condition around the vehicle V may be omitted. In contrast, only the mechanism changing the inclination of the LiDAR apparatus 50 based on the road condition around the vehicle V may be used, and the mechanism changing the inclination of the first reflection surface 41 based on the road condition around the vehicle V may be omitted.

As described above, according to the second embodiment, the laser light Ray 1 transmitted from the LiDAR apparatus 50 can be transmitted to the appropriate range based on the road condition around the vehicle V.

This can be achieved because the mechanism changing the inclination of the first reflection surface 41 based on the road condition around the vehicle V and the mechanism changing the inclination of the LiDAR apparatus 50 based on the road condition around the vehicle V are provided. In addition, the second embodiment can achieve effects similar to the effects by the first embodiment.

Modified examples are described.

In the above-described embodiments, the example in which the vehicle lamp according to the present disclosure is applied to the vehicle head lamps is described; however, the application is not limited thereto. For example, the vehicle lamp according to the present disclosure may be applied to a vehicle signal lamp or other vehicle lamps.

In the above-described embodiments, the example in which the scanning LiDAR apparatus 50 is used as the LiDAR apparatus is described; however, the LiDAR apparatus is not limited thereto. As the LiDAR apparatus, a flash LiDAR apparatus (not illustrated) or other LiDAR apparatuses may be used.

The numerical values described in the above-described embodiments are all illustrative, and appropriate numerical values different from the numerical values described in the above-described embodiments can be used as a matter of course.

The above-described embodiments are merely illustrative in all aspects. The present disclosure is not limitedly interpreted by the description of the above-described embodiments. The present disclosure can be implemented in other various forms without departing from the spirit or main features of the present disclosure.

This application is based on and claims the benefit of priority from Japanese Patent Application No. 2022-040358 filed on Mar. 15, 2022, the contents of which are hereby incorporated by reference.

### REFERENCE SIGNS LIST

1 . . . VEHICLE SYSTEM, 10 . . . VEHICLE LAMP, 20 . . . LOW-BEAM LAMP UNIT, 30 . . . HIGH-BEAM LAMP UNIT, 40, 40A . . . MOVABLE LIDAR APPARATUS, 41 . . . FIRST REFLECTION SURFACE, 42 . . . SECOND REFLECTION SURFACE, 43 . . . SLIDE MECHANISM (LIGHT CONTROL MECHANISM), 43a . . . MOTOR, 43b . . . ROTARY SHAFT, 43c . . . JOINT, 44 BRACKET, 45a . . . PIVOT, 45b . . . FIRST AIMING NUT, 45c . . . FIRST AIMING SCREW, 45d . . . MOTOR, 45e . . . SECOND AIMING NUT, 45f . . . SECOND AIMING SCREW, 45g . . . MOTOR, 46a . . . PIVOT, 46b . . . THIRD AIMING NUT, 46c . . . THIRD AIMING SCREW, 46d . . . MOTOR, 47 . . . BRACKET, 50 . . . LiDAR APPARATUS, 50a . . . LIGHT SOURCE CONTROL UNIT, 50b . . . MIRROR CONTROL UNIT, 50c . . . SIGNAL PROCESSING UNIT, 50d . . . CORRECTION UNIT, 51 . . . LIGHT SOURCE, 52 . . . BEAM SPLITTER, 53 . . . LIGHT DEFLECTOR, 53a . . . MEMS MIRROR, 54 . . . LIGHT RECEPTION ELEMENT, 55 CASE, 55a . . . OPENING PORTION, 56 . . . CONTROL UNIT, 57 . . . MEMORY, 58 . . . STORAGE UNIT, 58a . . . CORRECTION DATA, 60 . . . OUTER LENS, 70 . . . HOUSING, 80 . . . IMAGING APPARATUS, 90 . . . CONTROL UNIT, 91 STORAGE UNIT, 91A . . . PREDETERMINED PROGRAM, 92 . . . ROAD CONDITION DETERMINATION UNIT, 93 . . . LIGHT CONTROL UNIT, 100 . . . OPTICAL ELEMENT, 200 . . . REFLECTION MIRROR, A1 . . . FIRST DETECTION RANGE, A2 . . . SECOND DETECTION RANGE

1. A vehicle lamp, comprising:
a LiDAR apparatus including a light source configured to emit light for detecting a detection object transmitted to a first detection range, and a light reception element configured to output, in a case where return light as reflected light of the light for detecting the detection object reflected by the detection object enters the light reception element, an electric signal corresponding to intensity of the return light; and
a light control mechanism configured to control a transmission range of the light for detecting the detection object, based on a road condition around a vehicle.

2. The vehicle lamp according to claim 1, wherein the light control mechanism includes a first reflection surface designed to reflect and transmit the light for detecting the detection object emitted from the light source, to a second detection range wider than the first detection range, a second reflection surface, and a first actuator configured to move the second reflection surface to a first position out of an optical path of the light for detecting the detection object reflected by the first reflection surface or a second position on the optical path of the light for detecting the detection object reflected by the first reflection surface, based on the road condition around the vehicle.

3. The vehicle lamp according to claim 1, wherein the light control mechanism includes a first reflection surface designed to reflect and transmit the light for detecting the detection object emitted from the light source, to a second detection range wider than the first detection range, and a second actuator configured to change an inclination of the first reflection surface based on the road condition around the vehicle.

4. The vehicle lamp according to claim 1, wherein the light control mechanism includes a first reflection surface designed to reflect and transmit the light for detecting the detection object emitted from the light source, to a second detection range wider than the first detection range, and a third actuator configured to change an inclination of the LiDAR apparatus based on the road condition around the vehicle.

5. The vehicle lamp according to claim 1, wherein the light control mechanism includes a first reflection surface designed to reflect and transmit the light for detecting the detection object emitted from the light source, to a second detection range wider than the first detection range, and an optical element disposed on an optical path of the light for detecting the detection object reflected by the first reflection surface and configured to be switched to a first state of allowing the light for detecting the detection object reflected by the first reflection surface to pass therethrough or a second state of reflecting the light for detecting the detection object reflected by the first reflection surface, based on the road condition around the vehicle.
